(19) United States
(12) Patent Application Publication
(10) Pub. No.: US 2017/0247913 A1
(43) Pub. Date: Aug. 31, 2017

(54) SECONDARY BLOCKING MECHANISM FOR A LOCK SYSTEM INCLUDING A SOLENOID

(71) Applicant: Sentry Safe, Inc., Rochester, NY (US)

(72) Inventors: Ed Horeth, Rochester, NY (US); Raymond J. Stein, Canandaigua, NY (US)

(21) Appl. No.: 15/055,218

(22) Filed: Feb. 26, 2016

(51) Int. Cl. E05B 65/00; E05B 47/00; E05B 49/00

(52) U.S. Cl. CPC E05B 65/0082; E05B 49/00; E05B 47/0004; E05B 2047/0092

(57) ABSTRACT

A lock system for an enclosure comprises a locking mechanism selectively disposed in a locked or unlocked position. A first blocking pin prevents the locking mechanism from being moved to the unlocked position when disposed in a first blocking position via a first biasing mechanism. A solenoid mechanism imposes a force on the first blocking pin when in an energized state so that the first blocking pin is placed in an unblocking position. A second magnetizable blocking pin remains in contact with the first blocking pin when the solenoid mechanism is in an unenergized state. A second biasing mechanism biases the second blocking pin toward an unblocking position. During normal operation, the secondary biasing mechanism maintains the second blocking pin in its unblocking position so that the second blocking pin is separated from the first blocking pin when the solenoid mechanism is in the energized state.

### FIELD OF THE INVENTION

The present invention relates to a lock system that uses a blacker pin to either block movement of a locking mechanism or allow movement of the locking mechanism; more particularly, a lock system including a solenoid assembly that uses a blocking pin and a secondary blocking mechanism to prevent unauthorized retraction of the blocking pin through use of an external magnet.

### BACKGROUND OF THE INVENTION

It is common for individuals to store money, documents, firearms and other valuables within protective enclosures, such as safes, to restrict access to these items. Due to the nature of items stored in protective enclosures, there are instances in which persons seek to gain access to the interior of the protective enclosures without permission. Access to the interior of the protective enclosure is typically provided via a hinged door which has been adapted to selectively permit access to only authorized individuals. Historically, a locking mechanism operates in conjunction with one or more bolts to enable this selective accessibility.

A solenoid assembly may be positioned within the door of the protective enclosure and may be operably associated with the locking mechanism to move the locking mechanism, or allow the locking mechanism to be moved manually using a handle, between a locked position which secures the door in the closed position, and an unlocked position which allows the door to be moved to the open position.

A keypad assembly may be positioned on the front surface of the door and may be configured for actuating the solenoid assembly upon entry of a pre-established alpha/numeric sequence using the keypad assembly. This allows the locking mechanism to selectively disengage the door from the housing so that door the can be moved to the open position. Furthermore, a power source, such as a battery, may be located within the door and may be electrically connected to the keypad assembly and the solenoid assembly to provide the necessary power for operation of the keypad assembly and the solenoid assembly.

While the solenoid assembly may prevent unauthorized access to the enclosure interior under normal conditions, the solenoid assembly may be compromised by aggressive unauthorized attempts to access the interior. For instance, in certain orientations, the solenoid assembly may be actuated through an impact (such as by dropping or striking the enclosure body) to “bounce” the solenoid assembly such that the locking mechanism may be moved to the unlocked position without requiring an authorized access code being entered into the keypad. To alleviate the potential for a “bounce” attack, the solenoid assembly may be oriented such that the solenoid blocking pin is axially positioned normal to the front face of the door. This normal orientation, however, may be susceptible to manipulation using an external magnet, such as a rare earth magnet. That is, a magnet of sufficient magnetic field strength may be positioned proximate the external face of the door so as to provide sufficient drawing force to draw the solenoid blocking pin to an unlocked state and thereby allow the locking mechanism to move to the unlocked position.

Accordingly, there exists a need for a lock system that prevents the enclosure from being unlocked by using an external magnet. The present invention addresses this as well as other needs.

### SUMMARY OF THE INVENTION

In one aspect, a lock system for an enclosure including a housing and a door is provided. The housing defines an interior compartment and includes an access opening. The door is configured for being disposed in the access opening when in a closed position and the lock system is coupled to at least one of the housing or the door. The lock system comprises a locking mechanism configured for being selectively disposed in a locked position and an unlocked position. The locked position prevents the door from being moved from the closed position and the unlocked position allows the door to be moved from the closed position to allow access to the interior compartment. A first magnetizable blocking pin is configured for moving along a first linear path between a first blocking position and a first unblocking position. The first blocking pin prevents the locking mechanism from being moved to the unlocked position when disposed in the first blocking position. A first biasing mechanism is coupled with the first blocking pin. The first biasing mechanism imposes a first force on the first blocking pin in a first direction to place the first blocking pin in the first blocking position. A solenoid mechanism has an energized state and an unenergized state, The solenoid mechanism imposes a second force on the first blocking pin in a second direction opposite to the first direction in the energized state so that the first blocking pin is placed in the first unblocking position. The second force is greater than the first force. A second magnetizable blocking pin is configured for moving along the first linear path between a second blocking position and a second unblocking position. The second blocking pin remains in contact with the first blocking pin when the solenoid mechanism is in the unenergized state. A second biasing mechanism is coupled with the second blocking pin, wherein the second biasing mechanism imposes a third force on the second blocking pin in the first direction to place the second blocking pin in the second unblocking position. The third force maintains the second blocking pin in the second unblocking position so that the second blocking pin is separated from the first blocking pin when the solenoid mechanism is in the energized state to allow the locking mechanism to be moved to the unlocked position.

In another aspect, a secondary blocking mechanism for a lock system for an enclosure is provided, The enclosure includes a housing and a door, wherein the housing defines an interior compartment and includes an access opening. The door is configured for being disposed in the access opening when in a closed position. The lock system is coupled to at least one of the housing or the door and comprises a locking mechanism, a first magnetizable blocking pin, a first biasing mechanism, and a solenoid mechanism. The locking mechanism is configured for being selectively disposed in a locked position and an unlocked position, wherein the locked position prevents the door from being moved from the closed position and wherein the unlocked position allows the door to be moved from the closed position to allow access to the interior compartment. The first magnetizable blocking pin is configured for moving along a first linear path between a first blocking position and a first unblocking position, The first blocking pin prevents the locking mechanism from being moved to the unlocked position when disposed in the first blocking position. The first biasing mechanism is coupled with the first blocking pin and imposes a first force on the first blocking pin in a first direction to place the first blocking pin in the first blocking position. The solenoid mechanism has an energized state and an unenergized state wherein the solenoid mechanism imposes a second force on the first blocking pin in a second direction opposite to the first direction in the energized state so that the first blocking pin is placed in the first unblocking position. The second force is greater than the first force. The secondary blocking mechanism comprises a second magnetizable blocking pin configured for moving along the first linear path between a second blocking position and a second unblocking position. The second blocking pin remains in contact with the first blocking pin when the solenoid mechanism is in the unenergized state. A second biasing mechanism is coupled with the second blocking pin and imposes a third force on the second blocking pin in the first direction to place the second blocking pin in the second unblocking position. The third force maintains the second blocking pin in the second unblocking position so that the second blocking pin is separated from the first blocking pin when the solenoid mechanism is in the energized state to allow the locking mechanism to be moved to the unlocked position.

In yet another aspect, a method of selectively securing an enclosure using a lock system is provided, wherein the enclosure includes a housing and a door and the housing defines an interior compartment and includes an access opening while the door is configured for being disposed in the access opening when in a closed position. The lock system includes a locking mechanism, a first magnetizable blocking pin, a first biasing mechanism, a solenoid mechanism, and a secondary blocking mechanism. The locking mechanism is configured for being selectively disposed in a locked position and an unlocked position, wherein the locked position prevents the door from being moved from the closed position and wherein the unlocked position allows the door to be moved from the closed position to allow access to the interior compartment. The first magnetizable blocking pin is configured for moving along a first linear path between a first blocking position and a first unblocking position. The first blocking pin prevents the locking mechanism from being moved to the unlocked position when disposed in the first blocking position. The first biasing mechanism imposes a first force on the first blocking pin in a first direction to place the first blocking pin in the first blocking position. The solenoid mechanism has an energized state and an unenergized state, wherein the solenoid mechanism imposes a second force on the first blocking pin in a second direction opposite to the first direction in the energized state so that the first blocking pin is placed in the first unblocking position. The second force is greater than the first force. The secondary blocking mechanism includes a second magnetizable blocking pin and a second biasing mechanism. The second blocking pin is configured for moving along the first linear path between a second blocking position and a second unblocking position. The method comprises placing a magnet adjacent to the lock system when the solenoid mechanism is in the unenergized state; imposing a magnetic force on the first blocking pin and the second blocking pin in the second direction using the magnet; and magnetizing the first blocking pin and the second blocking pin using the magnet so that the first blocking pin and the second blocking pin are coupled with one another, wherein the second biasing mechanism imposes a third force on the second blocking pin in the first direction to place the second blocking pin in the second unblocking position and the first blocking pin in the first blocking position to place the locking mechanism in the locked position, and wherein the third force is greater than the magnetic force.

Additional objects, advantages and novel aspects of the present invention will be set forth in part in the description which follows, and will in part become apparent to those in the practice of the invention, when considered with the attached figures.

### BRIEF DESCRIPTION OF THE DRAWINGS

The accompanying drawings form a part of the this specification and are to be read in conjunction therewith, wherein like reference numerals are employed to indicate like parts in the various views, and wherein:

FIG. 1 is a front perspective view of an enclosure that may include a secondary blocking mechanism in accordance with an aspect of the present invention;

FIG. 2 is a perspective view of interior components of an enclosure door including the secondary blocking mechanism in accordance with an aspect of the present invention;

FIG. 3 is a partial side view of a prior art solenoid-type lock showing a solenoid blocking pin in the extended position;

FIG. 4 is a partial side view of the prior art solenoid-type lock shown in FIG. 3 with the solenoid blocking pin in the retracted position after the solenoid is energized;

FIG. 5 is a partial side view of the prior art solenoid-type lock shown in FIG. 3 with the solenoid blocking pin in the retracted position under influence of an external magnet;

FIG. 6 is a partial side view of a solenoid-type lock being used with the secondary blocking mechanism in accordance with an aspect of the present invention showing the solenoid blocking pin in the extended position and a second blocking pin in an unblocking position;

FIG. 7 is a partial side view of the solenoid-type lock in FIG. 6 with the solenoid blocking pin in the retracted position and the second blocking pin in the unblocking position after the solenoid mechanism is energized;

FIG. 8 is a partial side view of the solenoid-type lock in FIG. 6 with the solenoid blocking pin in the extended position and the second blocking pin in the unblocking position under influence of an external magnet having a magnetic field strength insufficient to overcome a biasing force imposed on the secondary blocking mechanism; and

FIG. 9 is a partial side view of the solenoid-type lock in FIG. 6 with the solenoid blocking pin in the retracted position and the second blocking pin in a blocking position under influence of an external magnet having a magnetic field strength sufficient to overcome a biasing force imposed on the secondary blocking mechanism.

### DETAILED DESCRIPTION OF THE INVENTION

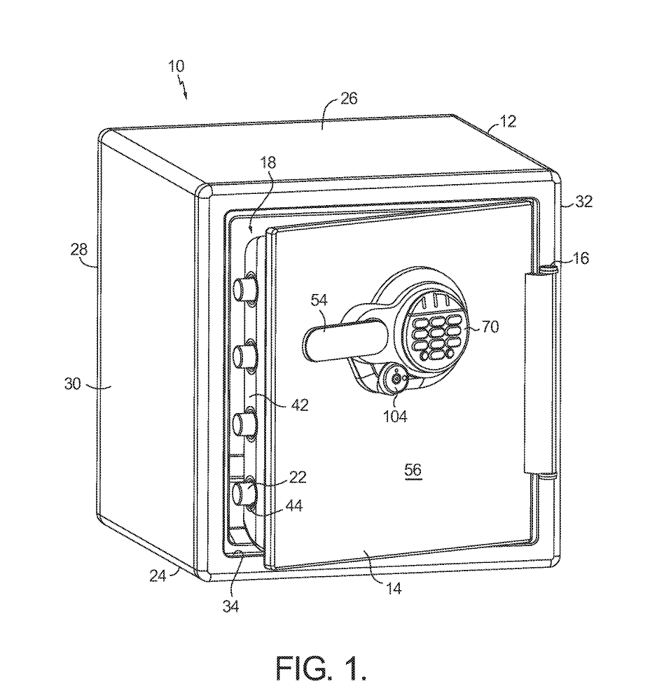

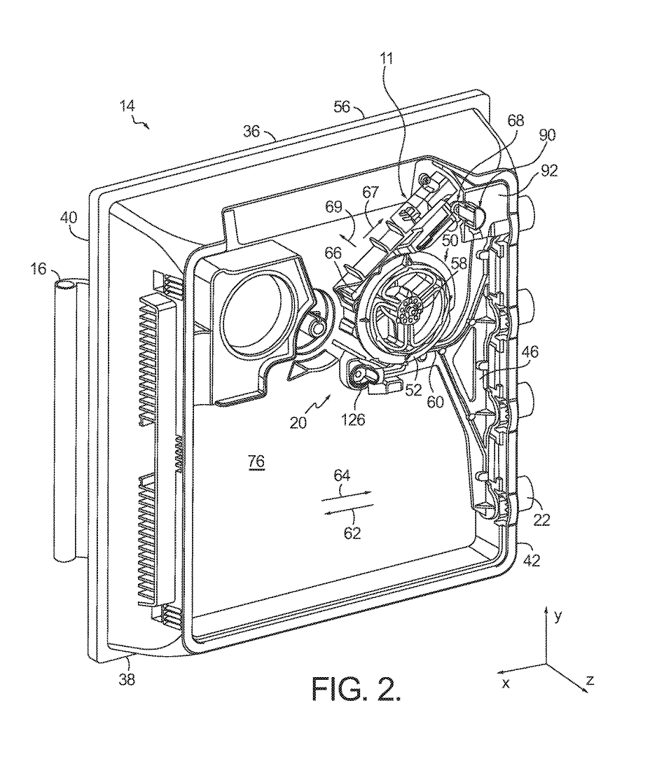

Referring now to the drawings in detail, and initially to FIGS. 1 and 6-9, reference numeral 10 generally designates a protective enclosure that may be used with a lock system 11 in accordance with the present invention. In general, as seen in FIG. 1, protective enclosure 10 includes a housing 12, a door 14, and at least one hinge 16 pivotably mounting door 14 to housing 12. Door 14 may be selectively moved between an open position to allow access to an interior compartment 18 defined by housing 12, and a closed position (not shown) to restrict access to interior compartment 18. Interior compartment 18 is defined by housing 12 and door 14 where valuables and other items may be stored and secured when door 14 is in the closed position. Protective enclosure 10 may further include a locking mechanism 20 (FIG. 2) that is mounted to door 14 and operates to selectively move between unlocked and locked positions to secure door 14 to housing 12 to restrict access to interior compartment 18 using one or more bolts 22.

Housing 12 may include a bottom wall 24, a top wall 26, a rear wall 28, and first and second opposing side walls 30, 32 extending between bottom wall 24 and top wall 26. Bottom wall 24, top wall 26, rear wall 28, and first and second opposing side walls 30, 32 define interior compartment 18 which may be used to store documents, firearms and other valuables. An access opening 34 is defined by bottom wall 24, top wall 26, rear wall 28, and first and second side walls 30, 32. Access opening 34 is configured for receiving door 14 when in the closed position, and allowing access to interior compartment 18 when door 14 is in the open position.

As best seen in FIG. 2, door 14 may generally include a top edge 36, an opposing bottom edge 38, a hinge edge 40, and opposing engagement edge 42. Hinge edge 40 includes hinge 16 that is configured for pivotally attaching door 14 to enclosure housing 12. In this manner, door 14 may be selectively pivoted between the dosed position, wherein access opening 34 of enclosure housing 12 is secured, to an opened position, wherein interior compartment 18 is accessible through access opening 34.

Locking mechanism 20 may be mounted to door 14 to selectively secure door 14 to housing 12. For example, locking mechanism 20 may include one or more locking bolts 22 configured to be selectively positioned in a locked (extended) position (FIGS. 1 and 2) and a unlocked (withdrawn) position (not shown) with respect to corresponding bolt recesses defined in access opening 34 to selectively secure door 14 to enclosure housing 12. Further, bolts 22 may be slidably positioned within corresponding bolt apertures 44 defined in engagement edge 42 and moved between the locked and unlocked positions. Also, bolts 22 may be connected to common longitudinally-oriented bolt bracket 46 so that all of bolts 22 move in conjunction with one another during movement between the locking and unlocking positions.

Further, as best seen in FIGS. 1 and 2, locking mechanism 20 may include a lock actuator 50 that selectively moves bolts 22, along with bolt bracket 46, between the locked and unlocked positions. Lock actuator 50 may include a rotating gear 52 driven by a handle 54 extending from an exterior surface 56 of door 14, wherein handle 54 is coupled with a spindle 58 that extends through an aperture in door 14 to selectively drive bolts 22 using gear 52. Gear 52 may include a plurality of teeth that are configured to mesh with corresponding teeth on a bracket rack 60 that is connected to bolt bracket 46. By rotating gear 52 using handle 54, both bracket rack 60 and bolt bracket 46 are translated, and thus bolts 22 are moved in either an inward retracted direction 62 or outward extended direction 64 depending on the rotational direction that handle 54 is turned.

In order to prevent unauthorized access to interior compartment 18, lock system 11 may further include a fence 66 and a solenoid assembly 68 that control whether lock actuator 50 can be used to retract or extend bolts 22. In particular, gear 52 include a plurality of teeth that are meshed with corresponding teeth formed in fence 66, whereby fence 66 translates in a first direction 67 upon rotation of spindle 58 via handle 54. First direction 67 may lie in an x-y plane, which may be generally parallel to at least a portion of exterior surface 56 of door 14. Fence 66 is configured to interact with solenoid assembly 68, wherein the position of one or more components within solenoid assembly 68 determines whether handle 54 and spindle 58 can be rotated to unlock locking mechanism 20. In one embodiment, a keypad assembly 70 (see FIG. 1) may be positioned on exterior surface 56 of door 14 is configured for actuating solenoid assembly 68 upon entry of a pre-established alpha/numeric sequence using keypad assembly 70. A properly authorized entry input allows locking mechanism 20 to selectively disengage door 14 from housing 12 so that door 14 can be moved to the open position, as will be discussed in more detail below. Furthermore, a power source, such as a battery (not shown), may be located within door 14 and may be electrically connected to keypad assembly 70 and solenoid assembly 68 to provide the necessary power for operation of these components.

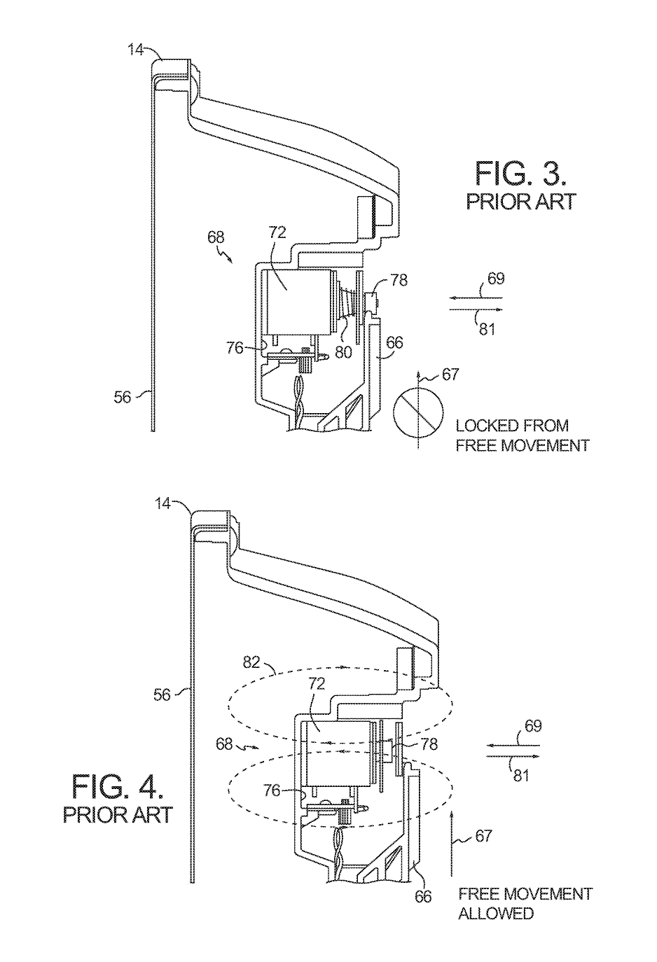

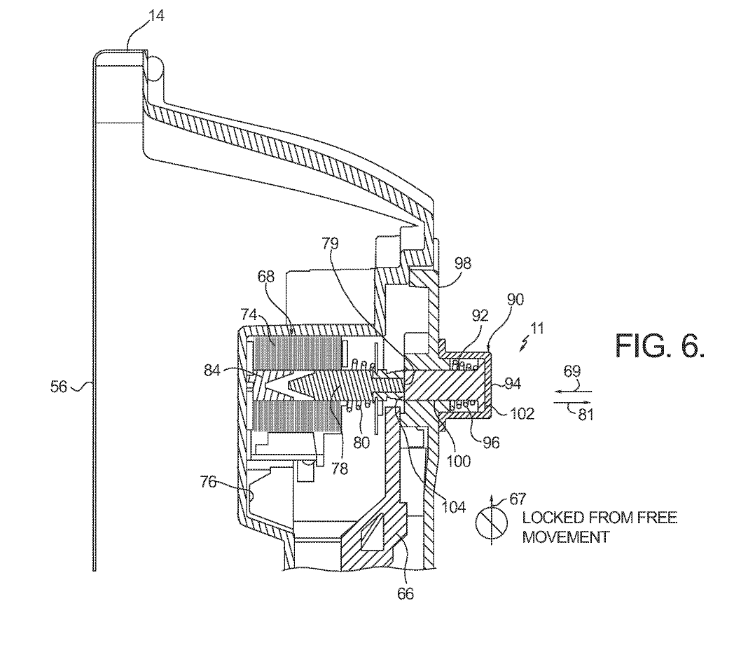

FIGS. 3-5 show enlarged side views of door 14 with portions broken away including an embodiment of a solenoid assembly 68 generally known in the art. Solenoid assembly 68 may include a solenoid coil 74 (see e.g., FIG. 6) within a housing 72 secured to an interior surface 76 of door 14, A magnetizable blocking pin 78 is disposed within sliding engagement with coil 74 and is configured for moving between between an extended blocking position (FIG. 3) and a retracted unblocking position (FIG. 4). A biasing mechanism, such as a spring 80 may be disposed between a head of solenoid blocking pin 78 and housing 72 to bias solenoid blocking pin 78 in a direction 81 toward the extended blocking position, wherein direction 81 is opposite of direction 69. As shown in FIG. 3, when solenoid blocking pin 78 is in its extended blocking position, actuation of gear 52 is prohibited from translating fence 66 in first direction 67 to an unlocked position because solenoid blocking pin 78 is in a position to impact fence 66, As such, bolts 22 cannot be withdrawn from their respective recesses in housing 12 thereby securing door 14 in a locked position. However, when an authorized alpha/numeric sequence is inputted using keypad assembly 70, a current is supplied to solenoid coil 74 thereby generating a magnetic field, generally indicated by field lines 82 in FIG. 4. The magnetic field generated by solenoid coil 74 overcomes the biasing force of solenoid spring 80 such that solenoid coil 74 operates to draw solenoid blocking pin 78 in a second direction 69 to its retracted position until solenoid blocking pin 78 abuts a solenoid stop 84 (see e,g., FIG. 6). In this manner, actuation of gear 52 may translate fence 66 in first direction 67, as described above, to permit full withdrawal of bolts 22 from their respective bolt recesses in housing 12 so as to unlock door 14 and permit access to internal compartment 18. Second direction 69 may be disposed in a plane that is perpendicular relative to first direction 67.

It should be noted that a prior art locking mechanism employing a solenoid assembly may be susceptible to external attacks to allow unauthorized access to the enclosure's interior. One such attack may be through an impact upon the enclosure of sufficient force that the solenoid blocking pin retracts without the solenoid coil being supplied with electrical current, This type of “bounce” attack may be minimized by aligning the solenoid assembly so that the movement of the solenoid pin is normal to the external surface of the door of the enclosure, such as that shown in FIGS. 2-9. While reducing the probability of a successful bounce attack, positioning the solenoid assembly in this orientation nonetheless renders the solenoid assembly susceptible to manipulation by an external magnet, particularly a rare earth magnet such as, for example, neodymium- or samarium-based magnets.

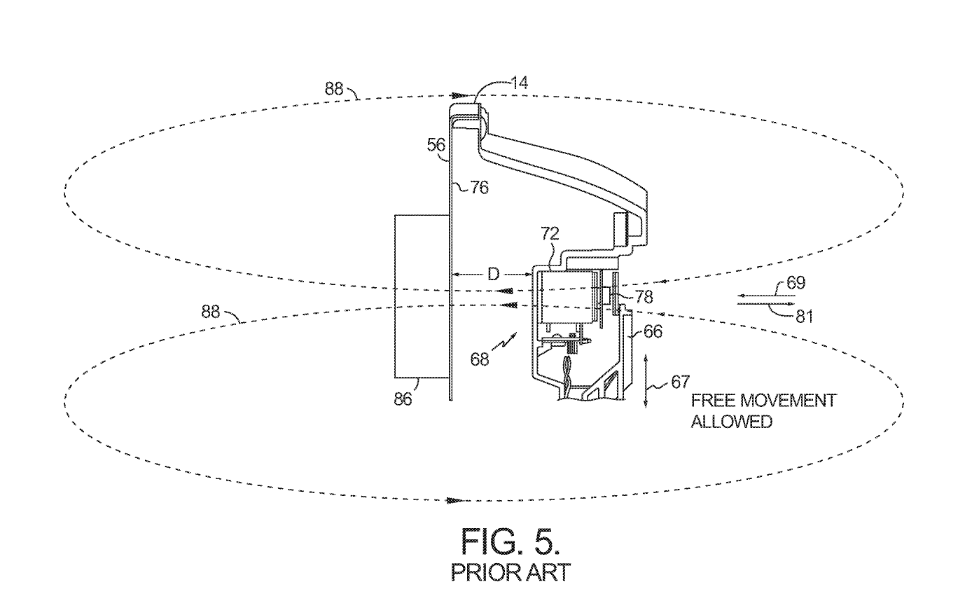

An example of an external magnet attack is shown generally in FIG. 5. As seen in FIG. 5, an external magnet 86 may be placed adjacent exterior surface 56 of door 14 such that external magnet 86 pulls solenoid blocking pin 78 in direction 69 to the retracted position without any current being supplied to solenoid coil 74. Prior attempts to overcome external magnet attacks include, for example, building out a thickness of door 14 to enable spacing of solenoid assembly 68 a distance D away from door 14. Distance D may be selected such that the magnetic field strength of the external magnet, shown generally by field lines 88, is insufficient to draw solenoid blocking pin 78 to the retracted position. However, the availability of very strong magnets, such as rare earth magnets, may lead to successful attacks against these types of enclosure configurations. Size and space limitations within enclosure 10 make it difficult to increase the distance between door 14 and solenoid mechanism 68. As a result, rare earth magnets may possess strong enough magnetic field strengths such that these fields traverse distance D and allow for unauthorized access to interior compartment 18. As such, a solution is needed to prevent unauthorized access to interior compartment 18 when attacked by a rare earth magnet.

In accordance with an aspect of the present invention, as best seen in FIGS. 6-9, a secondary blocking mechanism 90 is provided that may be used to prevent unauthorized access to interior compartment 18 of enclosure 10 using a rare earth magnet. Secondary blocking mechanism 90 may include a magnetizable second blocking pin 92, a biasing mechanism 96, and an optional cap 94. Secondary blocking mechanism 90 may be used with a cover 98 that is disposed over interior surface 76 of door 14 to enclose locking mechanism 20 and solenoid assembly 68 therebetween. Cover 98 may define an aperture 100 configured to slidably receive second blocking pin 92. It should be understood that cap 94 may be integrally formed with cover 98 or cap 94 may be otherwise secured to cover 98 by any suitable coupling, such as but not limited solely thereto, a snap fit, a threaded connection, an adhesively bonded connection, or the like so that second blocking pin 92 is disposed in cap 94. Biasing mechanism 96, such as a blocker spring, may be disposed within cap 94 and disposed between a head 102 of second blocking pin 92 and cover 98 to urge second blocking pin 92 in direction 81. Second blocking pin 92 may be axially aligned with, and in contact with, solenoid blocking pin 78 when solenoid mechanism 68 is in the unenergized state. At least a portion of second blocking pin 92 comprises a magnetic material, such as but not limited to iron or steel. As shown in FIG. 6, when locking mechanism 20 is in the locked orientation, solenoid blocking pin 78 is biased in the extended blocking position by solenoid spring 80 such that a top end 79 of solenoid blocking pin 78 may be in contact with a bottom end 104 of second blocking pin 92 which is biased in an unblocking position by blocker spring 96.

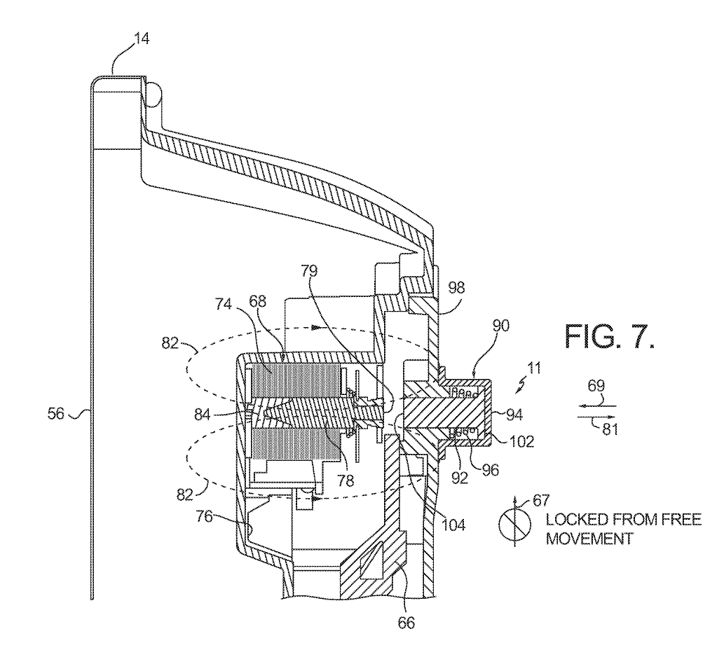

As best seen in FIG. 7, upon proper input of an authorized input code, such as by using keypad 70, solenoid coil 74 is energized and generates a magnetic field generally indicated by field lines 82, The strength of magnetic field 82 is selected so as overcome the biasing force of solenoid spring 80 and thereby draws solenoid blocking pin 78 in second direction 69 toward solenoid stop 84 without overcoming the biasing force of blocker spring 96 such that second blocking pin 92 remains in the unblocking position. In this manner, actuation of handle 54 actuates gear 52, which in turn translates fence 66 in the first direction 67 as described above so as to enable full withdrawal of bolts 22 from their respective bolt recesses in housing 12 to unlock door 14 and permit access to internal compartment 18.

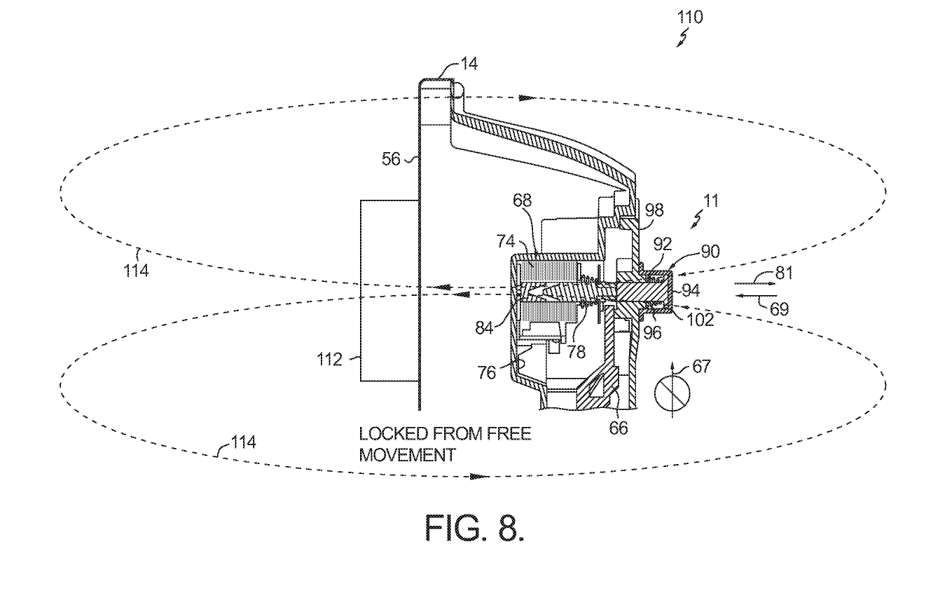

FIG. 8 illustrates a first scenario 110 of an external attack wherein locking mechanism 20 including secondary blocking mechanism 90 is exposed to an external magnet 112 generating a magnetic field (generally indicated by field lines 114) having a first magnetic strength. In scenario 110, external magnet 112 is placed adjacent external surface 56 of door 14 such that the magnetic field is sufficiently strong enough so as to magnetize solenoid blocking pin 78 and second blocking pin 92. As a result, solenoid blocking pin 78 may be magnetically attracted to, and magnetically coupled with, second blocking pin 92. The magnetic field strength 114 of external magnet 112, however, is insufficient to overcome the biasing force exerted on head 102 of second blocking pin 92 by blocker spring 96 such that the second blocking pin 92 remains in the unblocking position. Due to the magnetic coupling of solenoid blocking pin 78 and second blocking pin 92, solenoid blocking pin 78 remains in its extended position. Because solenoid blocking pin 78 is maintained in the extended position, actuation of handle 54 is limited such that gear 52 is prevented from translating fence 66 and bolts 22 remain lockingly engaged within their respective bolt recesses in housing 12. In this manner, door 14 remains secured to housing 12 and internal compartment 18 is inaccessible.

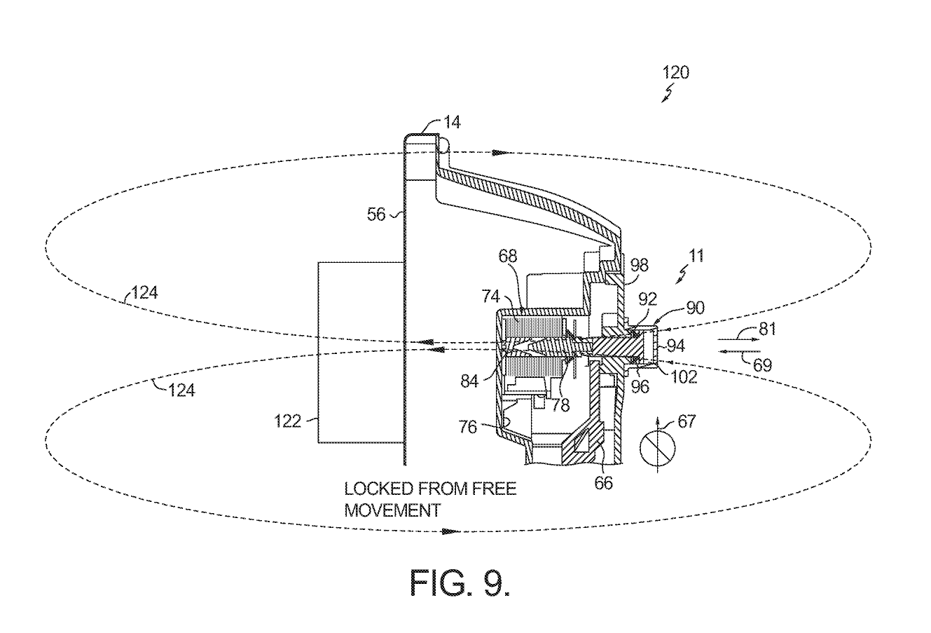

FIG. 9 shows a second scenario 120 of an external attack wherein locking mechanism 20 including secondary blocking mechanism 90 is exposed to an external magnet 122 generating a magnetic field (generally indicated by filed lines 124) having a second magnetic strength. As was the case with scenario 110 above, in scenario 120, external magnet 122 is placed adjacent exterior surface 56 of door 14 such that the magnetic field is sufficiently strong enough to magnetize solenoid blocking pin 78 and second blocking pin 92. As a result, solenoid blocking pin 78 may be magnetically attracted to, and magnetically coupled with, second blocking pin 92. Unlike scenario 110, however, the magnetic field strength of external magnet 122 is now sufficient to overcome the biasing force exerted on head 102 of second blocking pin 92 by blocker spring 96. As a result, second blocking pin 92 is drawn in second direction 69 toward the blocking position. Likewise, the coupled solenoid blocking pin 78 is drawn in the second direction 69 to its retracted position, Because secondary locking pin 92 is drawn to a blocking position due to the high magnetic field strength of external magnet 122, actuation of handle 54 is limited such that gear 52 is prevented from translating fence 66 in the direction 67 and bolts 22 remain lockingly engaged within their respective bolt recesses in housing 12. In this manner, door 14 remains secured to housing 12 such that internal compartment 18 is inaccessible.

While the above descriptions disclose cap 94 configured to restrict movement of second blocking pin 92 in direction 81 to the unblocking position due to the bias of biasing mechanism 96, it should be understood that other or additional travel limiting mechanisms may be employed. By way of example, and by no means limiting specifically thereto, second blocking pin 92 may define a recess configured to engage a post defined on cover 98 or other portion of door 14. The recess may be defined within the body of second blocking pin 92 so that the recess does not extend to either end of the pin. In this manner, second blocking pin 92 may reciprocally travel in directions 69 and 81 a distance defined by the length of the recess, with the post impacting the recess wall and preventing any further travel of the pin in that direction. Similarly, aperture 100 on cover 98 may be proportioned to reside within a circumferential valley defined within second blocking pin 92 where opposing ends of second blocking pin 92 have a greater diameter that aperture 100, As a result, travel of the pin is limited to the length of the circumferential valley until either end of second blocking pin 92 impacts cover 98. Other travel limiting configurations may also be suitably employed, and such additional travel limiters are to be considered within the teachings of the present invention.

As best seen in FIG. 2, lock system 11 may optionally include a secondary key 126 that operates to rotate a dog between locked and unlocked positions. In the locked position, the dog is positioned adjacent to bracket rack 60 so that gear 52 cannot be used to move bolts 22 to the retracted position. Secondary key 126 can be operated to rotate the dog to the unlocked position so that the dog does not prevent gear 52 from rotating bolts 22 to the retracted position. Further, to prevent unnecessary and unwanted over-translation of bolts 22 when moving bolts 22 to the fully retracted position, bolt bracket 46 may be configured to contact gear 52.

The foregoing description of the preferred embodiment of the invention has been presented for the purpose of illustration and description. It is not intended to be exhaustive nor is it intended to limit the invention to the precise form disclosed. It will be apparent to those skilled in the art that the disclosed embodiments may be modified in light of the above teachings. The embodiments described are chosen to provide an illustration of principles of the invention and its practical application to enable thereby one of ordinary skill in the art to utilize the invention in various embodiments and with various modifications as are suited to the particular use contemplated. Therefore, the foregoing description is to be considered exemplary, rather than limiting, and the true scope of the invention is that described in the following claims.

1. A lock system for an enclosure, wherein the enclosure includes a housing and a door, wherein the housing defines an interior compartment and includes an access opening, wherein the door is configured for being disposed in the access opening when in a closed position, and wherein the lock system is coupled to at least one of the housing or the door, the lock system comprising:
a locking mechanism configured for being selectively disposed in a locked position and an unlocked position, wherein the locked position prevents the door from being moved from the dosed position, and wherein the unlocked position allows the door to be moved from the dosed position to allow access to the interior compartment;
a first magnetizable blocking pin configured for moving along a first linear path between a first blocking position and a first unblocking position, wherein the first blocking pin prevents the locking mechanism from being moved to the unlocked position when disposed in the first blocking position;
a first biasing mechanism coupled with the first blocking pin, wherein the first biasing mechanism imposes a first force on the first blocking pin in a first direction to place the first blocking pin in the first blocking position;
a solenoid mechanism having an energized state and an unenergized state, wherein the solenoid mechanism imposes a second force on the first blocking pin in a second direction opposite to the first direction in the energized state so that the first blocking pin is placed in the first unblocking position, and wherein the second force is greater than the first force;
a second magnetizable blocking pin configured for moving along the first linear path between a second blocking position and a second unblocking position, wherein the second blocking pin remains in contact with the first blocking pin when the solenoid mechanism is in the unenergized state; and
a second biasing mechanism coupled with the second blocking pin, wherein the second biasing mechanism imposes a third force on the second blocking pin in the first direction to place the second blocking pin in the second unblocking position, and wherein the third force maintains the second blocking pin in the second unblocking position so that the second blocking pin is separated from the first blocking pin when the solenoid mechanism is in the energized state to allow the locking mechanism to be moved to the unlocked position.

2. A lock system in accordance with claim 1, further comprising a locking fence that moves along a second linear path when the locking mechanism moves between the locked position and the unlocked position.

3. A lock system in accordance with claim 2, wherein the second linear path is perpendicular to the first linear path.

4. A lock system in accordance with claim 2, wherein the locking fence is configured for engaging either the first blocking pin or the second blocking pin to maintain the locking mechanism in the lock position.

5. A lock system in accordance with claim 2, wherein the locking mechanism further includes at least one bolt coupled with a bolt bracket, wherein the bolt bracket and the at least one bolt are movably mounted to the door, and wherein the at least one bolt is engageable with the housing to secure the door in the closed position.

6. A lock system in accordance with claim 5, wherein the locking mechanism further includes a handle rotatably mounted to the door, wherein the handle is coupled with the bolt bracket so that rotation of the handle in a first rotational direction operates to move the at least one bolt into engagement with the housing to secure the door in the closed position.

7. A lock system in accordance with claim 1, wherein at least one of the first biasing mechanism or the second biasing mechanism is a coil spring.

8. A lock system in accordance with claim 1, wherein the door includes a front surface that is disposed on a first plane, and wherein the first linear path is perpendicular to the first plane.

9. A lock system in accordance with claim 1, wherein the solenoid mechanism includes a coil and a stop, wherein the coil is configured to allow the first blocking pin to be slidably disposed therein, and wherein the stop is positioned to contact the first blocking pin when the first blocking pin is in the first unblocking position.

10. A lock system in accordance with claim 9, wherein the second blocking pin is slidably disposed within an aperture defined in a cover of the door.

11. A lock system in accordance with claim 10, further comprising a travel limiting feature associated with the second blocking pin, wherein the travel limiting feature is configured to set the second unblocking position of the second blocking pin.

12. A lock system in accordance with claim 11, wherein the travel limiting feature is a cap coupled with the cover of the door, and wherein the cover is positioned to contact the second blocking pin in the second unblocking position.

13. A lock system in accordance with claim 1, wherein a bottom end of the second blocking pin is in contact with a top end the first blocking pin when the solenoid mechanism is in the unenergized state.

14. A secondary blocking mechanism for a lock system for an enclosure, wherein the enclosure includes a housing and a door, wherein the housing defines an interior compartment and includes an access opening, wherein the door is configured for being disposed in the access opening when in a closed position, wherein the lock system is coupled to at least one of the housing or the door, wherein the lock system comprises a locking mechanism, a first magnetizable blocking pin, a first biasing mechanism, and a solenoid mechanism, wherein the locking mechanism is configured for being selectively disposed in a locked position and an unlocked position, wherein the locked position prevents the door from being moved from the closed position, wherein the unlocked position allows the door to be moved from the closed position to allow access to the interior compartment, wherein the first magnetizable blocking pin is configured for moving along a first linear path between a first blocking position and a first unblocking position, wherein the first blocking pin prevents the locking mechanism from being moved to the unlocked position when disposed in the first blocking position, wherein the first biasing mechanism is coupled with the first blocking pin, wherein the first biasing mechanism imposes a first force on the first blocking pin in a first direction to place the first blocking pin in the first blocking position, wherein the solenoid mechanism has an energized state and an unenergized state, wherein the solenoid mechanism imposes a second force on the first blocking pin in a second direction opposite to the first direction in the energized state so that the first blocking pin is placed in the first unblocking position, and wherein the second force is greater than the first force, the secondary blocking mechanism comprising:
a second magnetizable blocking pin configured for moving along the first linear path between a second blocking position and a second unblocking position, wherein the second blocking pin remains in contact with the first blocking pin when the solenoid mechanism is in the unenergized state; and
a second biasing mechanism coupled with the second blocking pin, wherein the second biasing mechanism imposes a third force on the second blocking pin in the first direction to place the second blocking pin in the second unblocking position, and wherein the third force maintains the second blocking pin in the second unblocking position so that the second blocking pin is separated from the first blocking pin when the solenoid mechanism is in the energized state to allow the locking mechanism to be moved to the unlocked position.

15. A secondary blocking mechanism in accordance with claim 14, wherein the lock system includes a locking fence that moves along a second linear path when the locking mechanism moves between the locked position and the unlocked position.

16. A secondary blocking mechanism in accordance with claim 15, wherein the second linear path is perpendicular to the first linear path.

17. A secondary blocking mechanism in accordance with claim 15, wherein the locking fence is configured for engaging either the first blocking pin or the second blocking pin to maintain the locking mechanism in the lock position.

18. A secondary blocking mechanism in accordance with claim 15, wherein the locking mechanism further includes at least one bolt coupled with a bolt bracket, wherein the bolt bracket and the at least one bolt are movably mounted to the door, and wherein the at least one bolt is engageable with the housing to secure the door in the closed position.

19. A secondary blocking mechanism in accordance with claim 18, wherein the locking mechanism further includes a handle rotatably mounted to the door, wherein the handle is coupled with the bolt bracket so that rotation of the handle in a first rotational direction operates to move the at least one bolt into engagement with the housing to secure the door in the closed position.

20. A secondary blocking mechanism in accordance with claim 14, wherein at least one of the first biasing mechanism or the second biasing mechanism is a coil spring.

21. A secondary blocking mechanism in accordance with claim 14, wherein the door includes a front surface that is disposed on a first plane, and wherein the first linear path is perpendicular to the first plane.

22. A secondary blocking mechanism in accordance with claim 14, wherein the solenoid mechanism includes a coil and a stop, wherein the coil is configured to allow the first blocking pin to be slidably disposed therein, and wherein the stop is positioned to contact he first blocking pin when the first blocking pin is in the first unblocking position.

23. A secondary blocking mechanism in accordance with claim 22, wherein the second blocking pin is slidably disposed within an aperture defined in a cover of the door.

24. A secondary blocking mechanism in accordance with claim 23, further comprising a travel limiting feature associated with the second blocking pin, wherein the travel limiting feature is configured to set the second unblocking position of the second blocking pin.

25. A secondary blocking mechanism in accordance with claim 24, wherein the travel limiting feature is a cap coupled with the cover of the door, and wherein the cover is positioned to contact the second blocking pin in the second unblocking position.

26. A secondary blocking mechanism in accordance with claim 14, wherein a bottom end of the second blocking pin is in contact with a top end the first blocking pin when the solenoid mechanism is in the unenergized state.

27. A method of selectively securing an enclosure using a lock system, wherein the enclosure includes a housing and a door, wherein the housing defines an interior compartment and includes an access opening, wherein the door is configured for being disposed in the access opening when in a closed position, wherein the lock system includes a locking mechanism, a first magnetizable blocking pin, a first biasing mechanism, a solenoid mechanism, and a secondary blocking mechanism,
wherein the locking mechanism is configured for being selectively disposed in a locked position and an unlocked position, wherein the locked position prevents the door from being moved from the closed position, wherein the unlocked position allows the door to be moved from the closed position to allow access to the interior compartment,
wherein the first magnetizable blocking pin is configured for moving along a first linear path between a first blocking position and a first unblocking position,
wherein the first blocking pin prevents the locking mechanism from being moved to the unlocked position when disposed in the first blocking position,
wherein the first biasing mechanism imposes a first force on the first blocking pin in a first direction to place the first blocking pin in the first blocking position,
wherein the solenoid mechanism has an energized state and an unenergized state, wherein the solenoid mechanism imposes a second force on the first blocking pin in a second direction opposite to the first direction in the energized state so that the first blocking pin is placed in the first unblocking position, wherein the second force is greater than the first force,
wherein the secondary blocking mechanism includes a second magnetizable blocking pin and a second biasing mechanism,
wherein the second blocking pin is configured for moving along the first linear path between a second blocking position and a second unblocking position, the method comprising:
placing a magnet adjacent to the lock system when the solenoid mechanism is in the unenergized state;
imposing a magnetic force on the first blocking pin and the second blocking pin in the second direction using the magnet; and
magnetizing the first blocking pin and the second blocking pin using the magnet so that the first blocking pin and the second blocking pin are coupled with one another,
wherein the second biasing mechanism imposes a third force on the second blocking pin in the first direction to place the second blocking pin in the second unblocking position and the first blocking pin in the first blocking position to place the locking mechanism in the locked position, and wherein the third force is greater than the magnetic force.

28. A method in accordance with claim 27, wherein the magnet is a rare earth magnet.

29. A method in accordance with claim 27, wherein the magnet is placed along the first linear path.

30. A method in accordance with claim 29, wherein the magnet is placed adjacent to an exterior surface of the door.

31. A method of selectively securing an enclosure using a lock system, wherein the enclosure includes a housing and a door, wherein the housing defines an interior compartment and includes an access opening, wherein the door is configured for being disposed in the access opening when in a dosed position, wherein the lock system is coupled to at least one of the housing or the door, wherein the lock system includes a locking mechanism, a first magnetizable blocking pin, a first biasing mechanism, a solenoid mechanism, and a secondary blocking mechanism,
wherein the locking mechanism is configured for being selectively disposed in a locked position and an unlocked position, wherein the locked position prevents the door from being moved from the dosed position, wherein the unlocked position allows the door to be moved from the dosed position to allow access to the interior compartment,
wherein the first magnetizable blocking pin is configured for moving along a first linear path between a first blocking position and a first unblocking position, wherein the first blocking pin prevents the locking mechanism from being moved to the unlocked position when disposed in the first blocking position,
wherein the first biasing mechanism is coupled with the first blocking pin, wherein the first biasing mechanism imposes a first force on the first blocking pin in a first direction to place the first blocking pin in the first blocking position,
wherein the solenoid mechanism has an energized state and an unenergized state, wherein the solenoid mechanism imposes a second force on the first blocking pin in a second direction opposite to the first direction in the energized state so that the first blocking pin is placed in the first unblocking position, wherein the second force is greater than the first force,
wherein the secondary blocking mechanism includes a second magnetizable blocking pin and a second biasing mechanism, wherein the second blocking pin is configured for moving along the first linear path between a second blocking position and a second unblocking position, and
wherein the second biasing mechanism imposes a third force on the second blocking pin in the first direction to place the second blocking pin in the second unblocking position, the method comprising:
placing a magnet adjacent to the lock systemwhen the solenoid mechanism is in the unenergized state; and
imposing a magnetic force on the first blocking pin and the second blocking pin in the second direction using the magnet,
wherein the magnetic force is greater than the third force imposed on the second blocking pin by the second biasing mechanism, and wherein the magnetic force moves the first blocking pin to the first unblocking position and moves the second blocking pin to the second blocking position to place the locking mechanism in the locked position.

32. A method in accordance with claim 31, wherein the magnet is a rare earth magnet.

33. A method in accordance with claim 31, wherein the magnet is placed along the first linear path.

34. A method in accordance with claim 33, wherein the magnet is placed adjacent to an exterior surface of the door.

35. A method in accordance with claim 31, further comprising the step of magnetizing the first blocking pin and the second blocking pin using the magnet so that the first blocking pin and the second blocking pin are coupled with one another.
